(19) United States
(12) Patent Application Publication
(10) Pub. No.: US 2023/0221016 A1
(43) Pub. Date: Jul. 13, 2023

(54) THERMOELECTRIC HEAT EXCHANGER FOR AN HVAC SYSTEM

(71) Applicant: Johnson Controls Tyco IP Holdings LLP, Milwaukee, WI (US)

(72) Inventors: Ankur Mishra, Patna (IN); Tuhin Ranjan, Bihar Sharif (IN); Akash Agrawal, Mumbai (IN); Sanjeev Kannan, Navi Mumbai (IN)

(21) Appl. No.: 18/095,415

(22) Filed: Jan. 10, 2023

Related U.S. Application Data
(63) Continuation of application No. 16/107,900, filed on Aug. 21, 2018.
(60) Provisional application No. 62/718,822, filed on Aug. 14, 2018.

(51) Int. Cl. F24F 5/00; F25B 21/04; F24F 13/30; F24F 110/20; F24F 110/30; F24F 110/70; F24F 110/10

(52) U.S. Cl. CPC F24F 5/0042; F25B 21/04; F24F 13/30; F24F 5/0046; F25B 2321/025; F24F 2110/20; F24F 2110/30; F24F 2110/70; F24F 2110/10; F24F 2005/0067

(57) ABSTRACT

The present disclosure relates to a heating, ventilation, and/or air conditioning (HVAC) system having a heat exchanger configured to thermally regulate a supply air flow, where the heat exchanger includes a thermoelectric device, a first plurality of fins coupled to the thermoelectric device, and a second plurality of fins coupled to the thermoelectric device. The first plurality of fins extend into a supply air flow path of the supply air flow to transfer thermal energy between the thermoelectric device and the supply air flow and the second plurality of fins convectively transfer thermal energy between the thermoelectric device and a working fluid exterior the supply air flow path.

### CROSS-REFERENCE TO RELATED APPLICATIONS

This is a continuation application of U.S. patent application Ser. No. 16/107,900, entitled “THERMOELECTRIC HEAT EXCHANGER FOR AN HVAC SYSTEM,” filed Aug. 21, 2018, which claims priority from and the benefit of U.S. Provisional Application No. 62/718,822, entitled “THERMOELECTRIC HEAT EXCHANGER FOR AN HVAC SYSTEM”, filed Aug. 14, 2018, each of which is hereby incorporated by reference in its entirety for all purposes.

### BACKGROUND

This disclosure relates generally to heating, ventilation, and air conditioning (HVAC) systems. Specifically, the present disclosure relates to a thermoelectric heat exchanger.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

A heating, ventilation, and air conditioning (HVAC) system may be used to thermally regulate an environment, such as a building, home, or other structure. Conventional HVAC systems generally include a vapor compression system, which includes heat exchangers, such as a condenser and an evaporator, that transfer thermal energy between the HVAC system and the environment. In many cases, a fluid to be conditioned, such as air, may flow across the evaporator to enable a heat transfer fluid within the evaporator, such as a refrigerant, to absorb thermal energy from the fluid to be conditioned. A compressor of the vapor compression system directs the refrigerant to a condenser, which may be used to release the absorbed thermal energy from the refrigerant. Unfortunately, refrigerant within typical vapor compression systems may become contaminated or diluted over time, which decreases an effectiveness of the refrigerant, and thus, decreases an efficiency of the vapor compression system. Moreover, typical vapor compression systems include a plurality of valves, pipes, and/or additional heat exchangers that may incur wear and degradation, thereby rendering the vapor compression system less effective. As such, typical vapor compression systems may, in some cases, reduce an operational efficiency of the HVAC system.

### SUMMARY

The present disclosure relates to a heating, ventilation, and/or air conditioning (HVAC) system having a heat exchanger configured to thermally regulate a supply air flow, where the heat exchanger includes a thermoelectric device, a first plurality of fins coupled to the thermoelectric device, and a second plurality of fins coupled to the thermoelectric device. The first plurality of fins extend into a supply air flow path of the supply air flow to transfer thermal energy between the thermoelectric device and the supply air flow and the second plurality of fins convectively transfer thermal energy between the thermoelectric device and a working fluid exterior the supply air flow path.

The present disclosure also relates to a heating, ventilation, and/or air conditioning (HVAC) system having a heat exchanger configured to thermally regulate a supply fluid, where the heat exchanger includes a first chamber that defines a first flow path for the supply fluid, a second chamber that defines a second flow path for a working fluid. The heat exchanger also includes a thermoelectric device disposed between the first chamber and the second chamber. The thermoelectric device includes a first heat exchange surface and a second heat exchange surface, where a first plurality of fins is coupled to the first heat exchange surface and extends into the first flow path and a second plurality of fins is coupled to the second heat exchange surface and extends into the second flow path. The thermoelectric device is configured to transfer thermal energy between the supply fluid and the working fluid.

The present disclosure also relates to a heating, ventilation, and/or air conditioning (HVAC) system having a thermoelectric heat exchanger including a first chamber defining a first flow path for a supply fluid, a second chamber adjacent the first chamber, where the second chamber defines a second flow path for a working fluid, and a thermoelectric device disposed within the first flow path. The thermoelectric device includes a first heat exchange surface and a second heat exchange surface coupled to a first fin array and a second fin array, respectively, where the first fin array extends into the first flow path and the second fin array extends into the second flow path. The thermoelectric device is configured to transfer thermal energy between the supply fluid and the working fluid via the first fin array and the second fin array.

### BRIEF DESCRIPTION OF THE DRAWINGS

Various aspects of this disclosure may be better understood upon reading the following detailed description and upon reference to the drawings in which:

FIG. 1 is a perspective view of an embodiment of a building that may utilize a heating, ventilation, and air conditioning (HVAC) system in a commercial setting, in accordance with an aspect of the present disclosure;

FIG. 2 is a perspective view of an embodiment of a packaged HVAC unit of the HVAC system of FIG. 1, in accordance with an aspect of the present disclosure;

FIG. 3 is a perspective view of an embodiment of a residential HVAC system, in accordance with an aspect of the present disclosure;

FIG. 4 is a schematic diagram of an embodiment of a vapor compression system that may be used in the packaged HVAC unit of FIG. 2 and the residential HVAC system of FIG. 3, in accordance with an aspect of the present disclosure;

FIG. 5 is a perspective view of an embodiment of a thermoelectric heat exchanger that may be used in the HVAC system of FIG. 1 and the residential HVAC system of FIG. 3, in accordance with an aspect of the present disclosure;

FIG. 6 is a perspective view of an embodiment of a pair of chambers disposed within the thermoelectric heat exchanger of FIG. 5, in accordance with an aspect of the present disclosure; and

FIG. 7 is a perspective view of an embodiment of the thermoelectric heat exchanger of FIG. 5, in accordance with an aspect of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As mentioned above, a heating, ventilation, and air conditioning (HVAC) system generally includes a vapor compression system that transfers thermal energy between a heat transfer fluid, such as a refrigerant, and a fluid to be conditioned, such as air. The vapor compression system may include a condenser and an evaporator that are fluidly coupled to one another via a conduit. A compressor may be used to circulate the refrigerant through the conduit, and thus, enable the transfer of thermal energy between the condenser and the evaporator. Unfortunately, effectiveness of the refrigerant may decrease over time, which may decrease an operational efficiency of the vapor compression system. Moreover, typical vapor compression systems may be relatively large, and thus, are limited in operation in spatially constrained environments.

It is presently recognized that conventional vapor compression systems may include certain components that incur wear over time, and thus, reduce an operational efficiency of HVAC systems. As such, it is recognized that it may be desirable to thermally regulate a fluid to be conditioned without the use of a vapor compression system that circulates a refrigerant. Moreover, it is desirable to decrease a size of conventional HVAC systems.

With the foregoing in mind, embodiments of the present disclosure are directed to a thermoelectric heat exchanger that is configured to condition a fluid without the use of a refrigerant. For example, the thermoelectric heat exchanger includes a pair of chambers, which extend between an upstream end portion and a downstream end portion of a housing of the thermoelectric heat exchanger. A first chamber of the pair of chambers defines a first flow path through the housing of the thermoelectric heat exchanger, while a second chamber of the pair of chambers defines a second flow path through the housing of the thermoelectric heat exchanger. A first array of cooling fins, referred to herein as a first fin array, and a second array of cooling fins, referred to herein as a second fin array, extend across the first and second flow paths, respectively, such that a fluid may flow across the first fin array and the second fin array. Thermoelectric heat exchanger elements, referred to herein as thermoelectric devices, are disposed between the first and second fin arrays, such that a first heat exchange surface of the thermoelectric devices is coupled to the first fin array, and a second heat exchange surface of the thermoelectric devices is coupled to the second fin array.

A controller of the thermoelectric heat exchanger may supply an electrical current to the thermoelectric devices, which may enable the thermoelectric devices to generate a temperature differential between the first heat exchange surface and the second heat exchange surface. For example, if the thermoelectric heat exchanger is operating in a cooling mode, the current supplied to the thermoelectric devices may enable the thermoelectric devices to transfer thermal energy from the first heat exchange surface to the second heat exchange surface, and thus, decrease a temperature of the first heat exchange surface and increase a temperature of the second heat exchange surface. As such, a temperature of the first fin array may be below an ambient temperature, while a temperature of the second fin array may be above the ambient temperature. A first flow generating device may direct a flow of supply air across the first fin array, such that the first fin array may absorb thermal energy from the supply air and condition the flow of supply air. A second flow generating device may direct a second flow of fluid, such as a flow of cooling air or ambient air, through the second flow path and across the second fin array. As noted above, the temperature differential between the first heat exchange surface and the second heat exchange surface may enable the thermoelectric device to transfer thermal energy absorbed from the first fin array to the second fin array. Accordingly, the cooling fluid may absorb thermal energy from the second fin array and transfer this thermal energy to an ambient environment. As such, the thermoelectric heat exchanger may be used to thermally regulate a fluid flow traversing the first flow path.

In some embodiments, the thermoelectric heat exchanger may further include a solar array including one or more solar panels, which are electrically coupled to a battery module of the thermoelectric heat exchanger. The solar array may charge the battery module, while the battery module may be configured to supply electrical energy to the thermoelectric devices or any other suitable components of the thermoelectric heat exchanger. Accordingly, the solar array may, in some embodiments, enable the thermoelectric heat exchanger to operate independently of a stationary or utility power grid. These and other features will be described below with reference to the drawings.

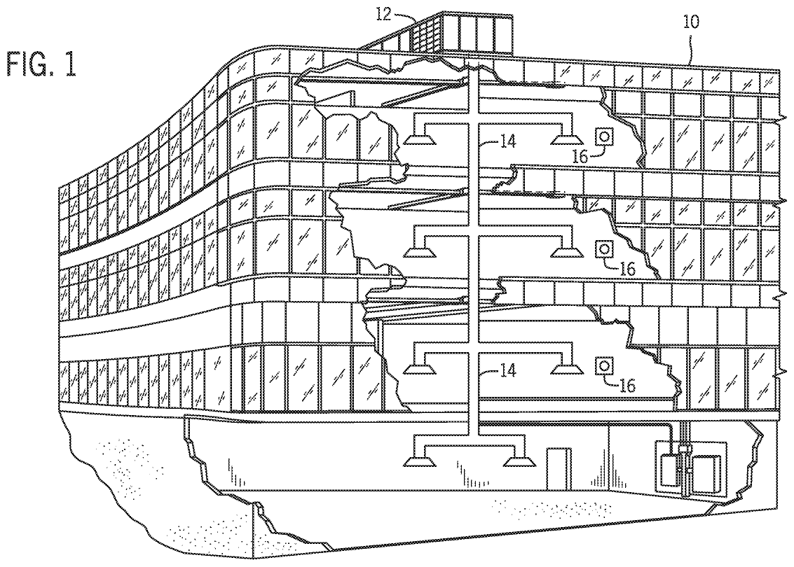

Turning now to the drawings, FIG. 1 illustrates an embodiment of a heating, ventilation, and/or air conditioning (HVAC) system for environmental management that may employ one or more HVAC units. As used herein, an HVAC system includes any number of components configured to enable regulation of parameters related to climate characteristics, such as temperature, humidity, air flow, pressure, air quality, and so forth. For example, an “HVAC system” as used herein is defined as conventionally understood and as further described herein. Components or parts of an “HVAC system” may include, but are not limited to, all, some of, or individual parts such as a heat exchanger, a heater, an air flow control device, such as a fan, a sensor configured to detect a climate characteristic or operating parameter, a filter, a control device configured to regulate operation of an HVAC system component, a component configured to enable regulation of climate characteristics, or a combination thereof. An “HVAC system” is a system configured to provide such functions as heating, cooling, ventilation, dehumidification, pressurization, refrigeration, filtration, or any combination thereof. The embodiments described herein may be utilized in a variety of applications to control climate characteristics, such as residential, commercial, industrial, transportation, or other applications where climate control is desired.

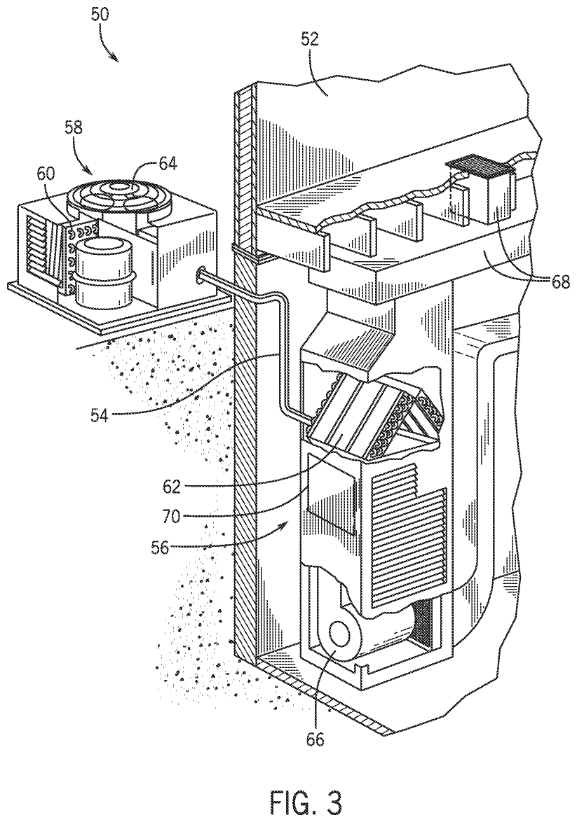

In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

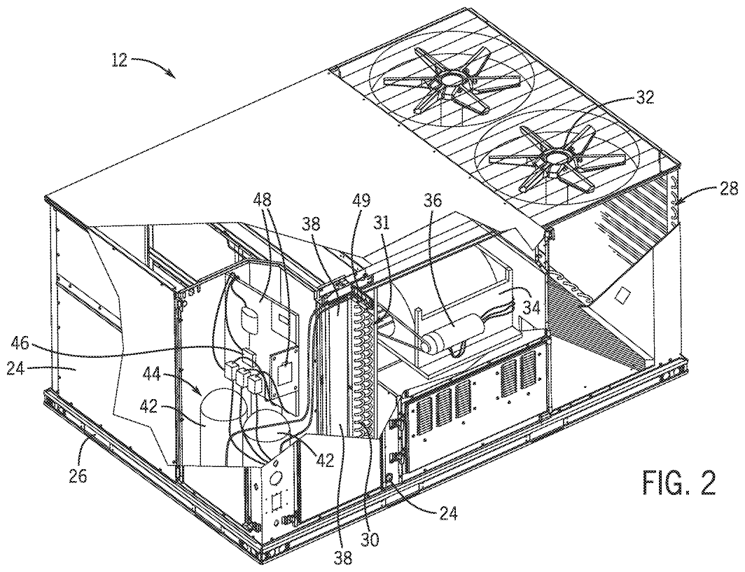

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant, such as R-410A, through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or a set point plus a small amount, the residential heating and cooling system 50 may become operative to refrigerate additional air for circulation through the residence 52. When the temperature reaches the set point, or a set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

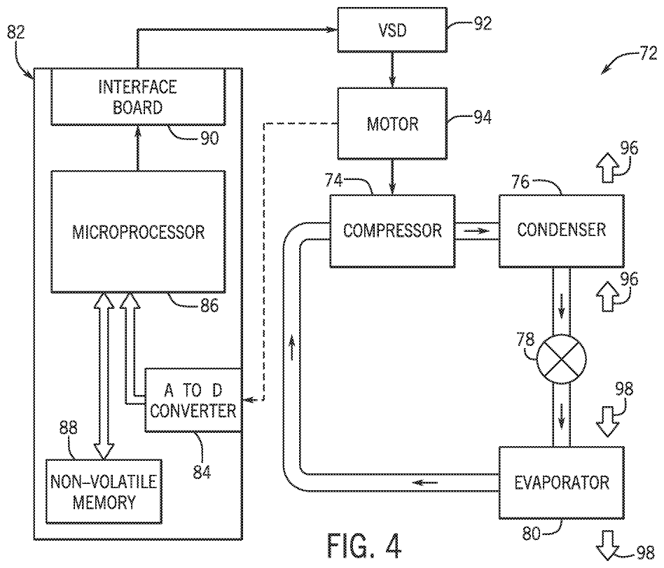

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or any other suitable HVAC systems. In some embodiments, the HVAC unit 12 is a designated heating system configured to operate in a heating mode and heat an air flow traversing through the HVAC unit 12. In other embodiments, the HVAC unit 12 may be a designated cooling system configured to operate in a cooling mode and cool, or condition, an air flow traversing through the HVAC unit 12. In yet further embodiments, the HVAC unit 12 may selectively transition between a heating mode or a cooling mode to heat or cool, respectively, an air flow traversing the HVAC unit 12. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

As discussed above, embodiments of the present disclosure are directed to a thermoelectric heat exchanger that may be used in addition to, or in lieu of, the vapor compression system 72. For example, the thermoelectric heat exchanger may be a component of the HVAC unit 12 of FIG. 2 or the residential heating or cooling system 50 of FIG. 3. In some embodiments, the thermoelectric heat exchanger may be used to pre-condition a flow of air or other fluid entering an economizer unit of the HVAC unit 12 or the residential heating or cooling system 50. Similarly, the thermoelectric heat exchanger may be used to pre-condition a flow of air that is subsequently directed across an evaporator, such as the evaporator 80. However, in other embodiments, the thermoelectric heat exchanger may discharge a conditioned flow of air directly into a conditioned space, such as the building 10, to facilitate thermal regulation of the conditioned space.

As described in greater detail herein, the thermoelectric heat exchanger may include one or more thermoelectric devices, such as Peltier cooling elements, which condition the air flowing through internal chambers of the thermoelectric heat exchanger. In some embodiments, the thermoelectric devices may be electrically coupled to a solar array including one or more solar panels, which may provide electrical energy to operate the thermoelectric devices. As such, the solar array may reduce a power draw of the thermoelectric heat exchanger from a utility power grid, such as an AC power grid or distribution system that is present near the system. Accordingly, the thermoelectric heat exchanger may reduce a power consumption of the HVAC system, thereby increasing an energy efficiency of the HVAC system.

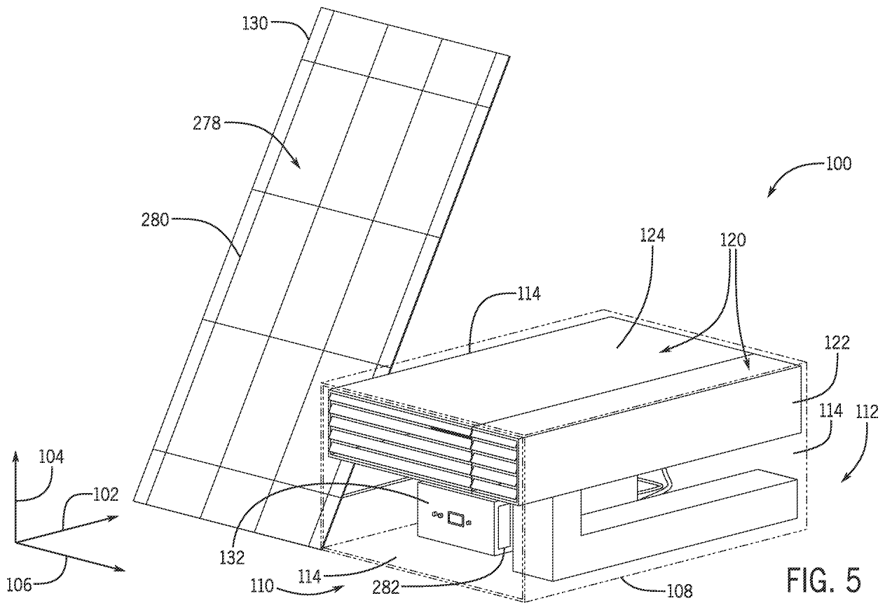

With the foregoing in mind, FIG. 5 is a perspective view of an embodiment of a temperature control system 100, referred to herein as a thermoelectric heat exchanger, which may be used to thermally regulate an air flow or other fluid. To facilitate discussion, the thermoelectric heat exchanger 100 and its components will be described with reference to a longitudinal axis or direction 102, a vertical axis or direction 104, and a lateral axis or direction 106. The thermoelectric heat exchanger 100 includes a housing 108, or an enclosure, that extends along the longitudinal direction 102 from an upstream end portion 110 of the thermoelectric heat exchanger 100 to a downstream end portion 112 of the thermoelectric heat exchanger 100. The housing 108 may be generally rectangular in shape and may be formed from sheet metal, aluminum, fiberglass, or any other suitable material. In some embodiments, the housing 108 may be constructed of multiple panels 114, such as side panels, top panels, and bottom panels, which are coupled to one another to collectively form the housing 108. The panels 114 may be coupled together using fasteners such as bolts, clamps, rivets, adhesives, or any other suitable fasteners. It should be noted that in some embodiments, the housing 108 may be constructed of additional or fewer panels than the panels 114 discussed above. While the illustrated embodiment of FIG. 5 shows the housing 108 as a generally rectangular prism, it should be noted that the housing 108 may include other suitable shapes.

In any case, the thermoelectric heat exchanger 100 includes a pair of chambers 120, or a pair of ducts, that are disposed within an interior region of the housing 108, generally parallel to the longitudinal direction 102. In particular, the pair of chambers 120 may include a conditioning chamber 122, or a first chamber, and a working fluid chamber 124, or a second chamber, which each extend from the upstream end portion 110 to the downstream end portion 112 of the thermoelectric heat exchanger 100. The conditioning chamber 122 and the working fluid chamber 124 each define a respective flow path configured to facilitate direction of a fluid flow from the upstream end portion 110 of the thermoelectric heat exchanger 100 to the downstream end portion 112 of the thermoelectric heat exchanger 100 or vice versa.

As described in greater detail herein, the thermoelectric heat exchanger 100 includes a plurality of thermoelectric devices that are disposed between and/or within the conditioning chamber 122 and the working fluid chamber 124. The thermoelectric devices are configured to transfer thermal energy between the respective fluid flows within the conditioning chamber 122 and the working fluid chamber 124. For example, when the thermoelectric heat exchanger 100 is operating in a cooling mode, the thermoelectric devices may enable the thermoelectric heat exchanger 100 to remove thermal energy from a first fluid flow within the conditioning chamber 122 and transfer the absorbed thermal energy to a second fluid flow within the working fluid chamber 124. Accordingly, the thermoelectric heat exchanger 100 may be used to condition a fluid flowing through the conditioning chamber 122. However, it should be noted that in other embodiments, the thermoelectric devices may be configured to transfer thermal energy from a fluid flow within the working fluid chamber 124 to a fluid flow within the conditioning chamber 122. As such, the thermoelectric heat exchanger 100 may operate in a heating mode and heat, rather than cool, a fluid flowing through the conditioning chamber 122. As discussed below, the thermoelectric heat exchanger 100 may further include a solar array 130 and a control unit 132, which may cooperate to facilitate efficient operation of the thermoelectric heat exchanger 100.

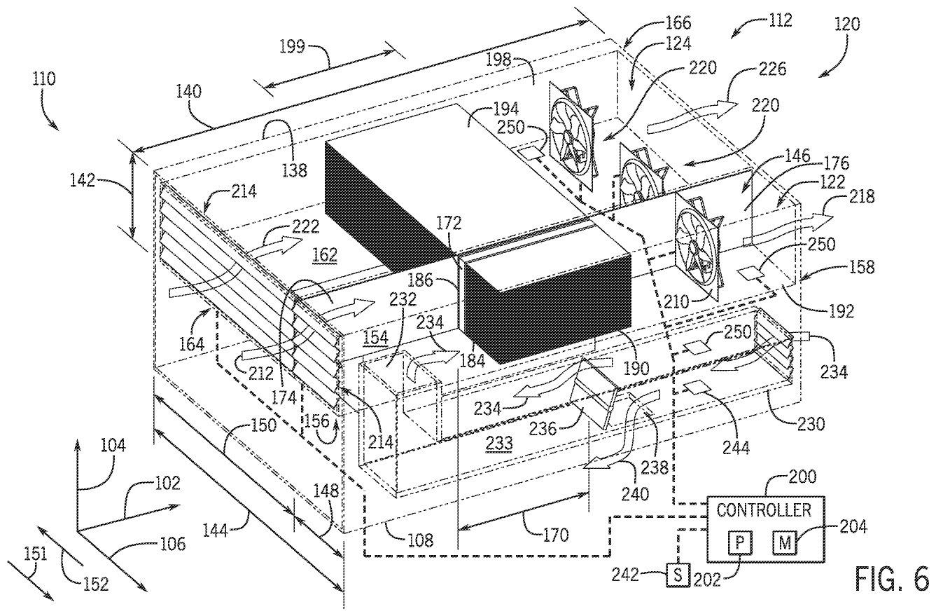

FIG. 6 is a perspective view of an embodiment of the thermoelectric heat exchanger 100, illustrating a central channel 138 that is disposed within the housing 108 and which includes the pair of chambers 120 of the thermoelectric heat exchanger 100. The central channel 138 has a length 140, a height 142, and a width 144 that extend generally parallel to the longitudinal direction 102, the vertical direction 104, and the lateral direction 106, respectively. A divider plate 146 is disposed within the central channel 138 and extends generally parallel to the longitudinal direction 102. The divider plate 146 is configured to bisect or divide the central channel 138 into the conditioning chamber 122 and the working fluid chamber 124. As such, the divider plate 146 may substantially block fluid flow between the conditioning chamber 122 and the working fluid chamber 124. A position of the divider plate 146 relative to the lateral axis 106 may define a first width 148 of the conditioning chamber 122 and a second width 150 of the working fluid chamber 124. Accordingly, translating the divider plate 146 in a lateral direction 151 may decrease the width 148 of the conditioning chamber 122 and increase the 150 width of the working fluid chamber 124. Conversely, translating the divider plate 146 in a direction 152, opposite the lateral direction 151, may increase the width 148 of the conditioning chamber 122 and decrease the width 150 of the working fluid chamber 124. As such, translating the divider plate 146 along the lateral axis 106 varies a cross-sectional area of both the conditioning chamber 122 and the working fluid chamber 124.

It should be noted that, in other embodiments, the pair of chambers 120 may include two individual ducts that are separate from one another and together form the pair of chambers 120, rather than a single channel, such as the central channel 138, which is subdivided to form each chamber of the pair of chambers 120. In any case, as noted above, the conditioning chamber 122 defines a first flow path 154, or a supply air flow path, that extends from a first end portion 156 to a second end portion 158 of the conditioning chamber 122. Similarly, the working fluid chamber 124 defines a second flow path 162, or a working air flow path, that extends from a first end portion 164 of the working fluid chamber 124 to a second end portion 166 of the working fluid chamber 124.

In some embodiments, the divider plate 146 includes a gap 170 or opening that is configured to receive one or more thermoelectric devices 172, such as one or more Peltier cooling elements. For example, a first portion 174 of the divider plate 146 may be disposed proximate to the upstream end portion 110 relative to the thermoelectric devices 172, while a second portion 176 of the divider plate 146 may be disposed proximate to the downstream end portion 112 relative to the thermoelectric devices 172. A height of the thermoelectric devices 172 may be substantially similar to the height 142 of the central channel 138 and, thus, a height of the divider plate 146. Accordingly, the thermoelectric devices 172 may extend across the gap 170 between the first portion 174 of the divider plate 146 and the second portion 176 of the divider plate 146 and may thus substantially block fluid flow between the first flow path 154 and the second flow path 162. In other embodiments, the divider plate 146 may extend continuously from the upstream end portion 110 to the downstream end portion 112 of the thermoelectric heat exchanger 100. In such embodiments, the divider plate 146 may include a series of apertures disposed within the divider plate 146, which are configured to receive the thermoelectric devices 172.

The thermoelectric devices 172 each include a first heat exchange surface 184 and a second heat exchange surface 186, opposite the first each exchange surface 184. As described in greater detail herein, the thermoelectric devices 172 may be configured to transfer thermal energy from the first heat exchange surface 184 to the second heat exchange surface 186 and vice versa. In some embodiments, the second heat exchange surface 186 may be disposed collinear to, or in the same plane as, the divider plate 146. Accordingly, at least a portion of the thermoelectric devices 172 extends into the first flow path 154. However, in other embodiments, the thermoelectric devices 172 may be disposed within the gap 170 such that a centerline of the thermoelectric devices 172 is collinear to the divider plate 146. As such, a first portion of the thermoelectric devices 172 may extend into the first flow path 154, while a second portion of the thermoelectric devices 172 extends into the second flow path 162.

A first plurality of heat exchanger fins 190, referred to herein as a first fin array 190, is coupled to the first heat exchange surface 184 of the thermoelectric devices 172. The first fin array 190 extends generally parallel to, or along, the lateral axis 106 from the first heat exchange surface 184 to a first exterior wall 192 of the conditioning chamber 122. A second plurality of fins 194, referred to herein as a second fin array 194, is coupled to the second heat exchange surface 186 of the thermoelectric devices 172. Similar to the first fin array 190, the second fin array 194 extends generally parallel to, or along, the lateral axis 106 from the second heat exchange surface 186 to a second exterior wall 198 of the working fluid chamber 124. The first fin array 190 and the second fin array 194 may each extend along the full height 142 of the central channel 138, such that the first fin array 190 extends across substantially all of the cross-sectional area of the conditioning chamber 122, while the second fin array 194 extends across substantially all of the cross-sectional area of the working fluid chamber 124. Accordingly, the first fin array 190 and the second fin array 194 extend across the first flow path 154 and the second flow path 162, respectively.

In some embodiments, each fin of the first and second fin arrays 190, 194 may include a cross-sectional shape that is generally rectangular. However, in other embodiments, the fins of the first and second fin arrays 190, 194 may include any suitable cross-sectional shape, such as circular, oval, square, triangular, etc. In some embodiments, the cross-sectional shape of the fins and an arrangement of the fins within each of the first and second fin arrays 190, 194 may be determined using computer modeling techniques, such as computational fluid dynamics software. The first fin array 190 and the second fin array 194 may be constructed of aluminum, copper, brass, or any other suitable thermally conductive material.

The first and second fin arrays 190, 194 each extend along a segmental length 199, which may be proportional to a length of the gap 170 or, in other words, a length of the thermoelectric devices 172. In some embodiments, the segmental length 199 may include one third of the length 140 of the central channel 138, one half of the length 140 of the central channel 138, or three quarters of the length 140 the central channel 138. It should be noted that in other embodiments, the segmental length 199 may include a portion of the length 140 that is greater than, or less than the portions of the length 140 discussed above. For example, in some embodiments, the segmental length 199 may extend along substantially all of the length 140 of the central channel 138. Further, while the respective segmental lengths 199 of the first and second fin arrays 190, 194 is shown as equal in the illustrated embodiment of FIG. 6, one of skill in the art would appreciate that a segmental length of the first fin array 190 may be greater than, or less than, a segmental length of the second fin array 194. In other words, the first and second fin array 190, 194 may extend beyond a length of the thermoelectric devices 172.

The thermoelectric devices 172 remain in a de-energized state while no electrical current is supplied thereto. Accordingly, a temperature of the first and second heat exchanges surfaces 184, 186 may be substantially similar to an ambient temperature of the conditioning chamber 122 and an ambient temperature of the working fluid chamber 124, respectively. This temperature will be referred to herein as a de-energized temperature of the thermoelectric devices 172. The thermoelectric devices 172 may electrically couple to a controller 200 disposed within the control unit 132 of the thermoelectric heat exchanger 100, which, as discussed in greater detail herein, may modulate a flow of electric current to the thermoelectric devices 172. As noted above, the thermoelectric devices 172 may generate a temperature differential between the first heat exchange surface 184 and the second heat exchange surface 186 while an electrical current is supplied thereto. Accordingly, the controller 200 may be used to modulate a temperature differential between the first and second heat exchange surfaces 184, 186 by adjusting a magnitude of the electrical current supplied to the thermoelectric devices 172.

One or more control transfer devices, such as wires, cables, wireless communication devices, and the like, may communicatively couple the thermoelectric devices 172 to the controller 200. The controller 200 may include a processor 202, such as a microprocessor, which may execute software for controlling the thermoelectric devices 172. Moreover, the processor 202 may include multiple microprocessors, a “general-purpose” microprocessor, a special-purpose microprocessor, and/or an application specific integrated circuit (ASICS), or some combination thereof.

For example, the processor 202 may include a reduced instruction set (RISC) processor. The controller 200 may also include a memory device 204 that may store information such as control software, look up tables, configuration data, etc. The memory device 204 may include a volatile memory, such as random access memory (RAM), and/or a nonvolatile memory, such as read-only memory (ROM). The memory device 204 may store a variety of information and may be used for various purposes. For example, the memory device 204 may store processor-executable instructions including firmware or software for the processor 202 to execute, such as instructions for controlling the thermoelectric devices 172. In some embodiments, the memory device 204 is a tangible, non-transitory, machine-readable-medium that may store machine-readable instructions for the processor 202 to execute. The memory device 204 may include ROM, flash memory, a hard drive, or any other suitable optical, magnetic, or solid-state storage medium, or a combination thereof. The memory device 204 may store data, instructions, and any other suitable data.

In some embodiments, the controller 200 may receive and regulate a flow of electrical current from a power source, such as an AC power grid or distribution system, to the thermoelectric devices 172. However, it should be noted that in other embodiments, the controller 200 may instruct a separate power regulating device to supply an appropriate electric current to the thermoelectric devices.

In any case, the thermoelectric devices 172 may receive a flow of electric current during operation of the thermoelectric heat exchanger 100, such that the thermoelectric devices 172 are energized. As noted above, this flow of electric current enables the thermoelectric devices 172 to generate a temperature differential between the first heat exchange surface 184 and the second heat exchange surface 186. As a non-limiting example, the thermoelectric devices 172 may generate a temperature differential between the first and second heat exchange surfaces 184, 186 that is approximately 20 degrees Celsius, 25 degrees Celsius, 30 degrees Celsius, or greater than 30 degrees Celsius. As described in greater detail herein, in some embodiments, the thermoelectric devices 172 may be arranged in a pyramidal or cascaded arrangement, which may enable the thermoelectric devices 172 to further increase a temperature differential between the first heat exchange surface 184 and the second heat exchange surface 184.

While operating the thermoelectric heat exchanger 100 in a cooling mode, energizing the thermoelectric devices 172 may enable the thermoelectric devices 172 to transfer thermal energy from the first heat exchange surface 184 to the second heat exchange surface 184. As such, a first temperature of the first heat exchange surface 184 decreases below the de-energized temperature while a second temperature of the second heat exchange surface 186 increases above the de-energized temperature. Accordingly, the thermoelectric devices 172 may decrease a temperature of the first fin array 190 and increase a temperature of the second fin array 194 coupled to the first and second heat exchange surfaces 184, 186, respectively.

It should be noted that the thermoelectric heat exchanger 100 may also operate in a heating mode, in which the controller 200 reverses a flow direction of the electrical current supplied to the thermoelectric devices 172. Reversing the flow direction of the electrical current also reverses a direction of heat transfer between the first heat exchange surface 184 and the second heat exchange surface 186. For example, in such cases, the thermoelectric devices 172 may transfer thermal energy from the second heat exchange surface 186 to the first heat exchange surface 184, thereby cooling the second fin array 194 and heating the first fin array 190. As discussed in greater detail herein, the controller 200 may modulate a magnitude and polarity of the electrical current supplied to the thermoelectric devices 172, and thus, adjust a temperature of each of the first fin array 190 and the second fin array 194.

A first flow generating device 210, such as an axial fan, a centrifugal fan, or the like, is disposed within the first flow path 154 of the conditioning chamber 122 and is configured to draw a flow of supply air 212 into the conditioning chamber 122 from an ambient environment. The first flow generating device 210 may be communicatively coupled to the controller 200, such that the controller 200 may instruct the first flow generating device 210 to increase or decrease a flow rate of the supply air 212 by increasing or decreasing, respectively, an operational speed of the first flow generating device 210. A first set of louvers 214 may be disposed near the first end portion 156 of the conditioning chamber 122 and may facilitate regulation of a flow rate of the supply air 212 in addition to the first flow generating device 210. For example, the controller 200 may be communicatively coupled to the first set of louvers 214 and instruct the first set of louvers 214 to move between a closed position and an open position. During operation of the first flow generating device 210, moving the first set of louvers 214 from the open position toward the closed position may decrease a flow rate of the supply air 212 while moving the first set of louvers 214 from the closed position toward the open position may increase a flow rate of the supply air 212.

The first flow generating device 210 may direct the supply air 212 across the first fin array 190. As such, a flow direction of the supply air 212 along the first flow path 154 may be crosswise to an orientation of the first fin array 190, which extends along direction 151. As noted above, the embodiments of the thermoelectric heat exchanger 100 discussed herein illustrate the thermoelectric heat exchanger 100 operating in a cooling mode, or a conditioning mode, in which the thermoelectric devices 172 are configured to decrease a temperature of the first fin array 190 and increase a temperature of the second fin array 194 by transferring thermal energy from the first fin array 190 to the second fin array 194. As such, the first fin array 190 may absorb thermal energy from the supply air 212 flowing across the first fin array 190 and along the first flow path 154, such that the thermoelectric device 172 may direct the absorbed thermal energy toward the second fin array 194. Accordingly, the supply air 212 may discharge from the first fin array 190 as conditioned air 218, which is at a temperature less than a temperature of the supply air 212. The conditioned air 218 is exhausted from the conditioning chamber 122 through the second end portion 158. In some embodiments, the downstream end portion 112 of the conditioning chamber 122 may be fluidly coupled to a structure, such as the building 10, via a system of ductwork, such as the ductwork 14. Accordingly, the first flow generating device 210, or a set of additional flow generating devices disposed within the ductwork 14, may direct the conditioned air 218 toward the building 10.

As noted above, in other embodiments, the thermoelectric heat exchanger 100 may be used to supplement an existing heating or cooling system, such as the HVAC unit 12. For example, the thermoelectric heat exchanger 100 may pre-condition a flow of air, such as the supply air 212, before directing the supply air 212 across, for example, the evaporator 80 of the HVAC unit 12. In such embodiments, the thermoelectric heat exchanger 100 is disposed upstream of the evaporator 80, with respect to a flow direction of the supply air 212 along the first flow path 154. Suitable ductwork, such as the ductwork 14, extends between the second end portion 158 of the conditioning chamber 122 and a heat exchange area of the evaporator 80. Accordingly, the first flow generating device 210, or an auxiliary flow generating device disposed within the ductwork 14, may direct the conditioned air 218 along the flow path 154 and across the heat exchange area of the evaporator 80. Accordingly, the thermoelectric heat exchanger 100 may be used to enhance an operational efficiency of conventional HVAC systems that include a vapor compression system, such as the vapor compression system 72. In still further embodiments, the thermoelectric heat exchanger 100 may be integrated with an economizer unit, and thus, pre-condition a flow of air entering the economizer unit.

In some embodiments, the thermoelectric heat exchanger 100 may be used to further condition a flow of air that is previously conditioned by the evaporator 80. In such embodiments, the thermoelectric heat exchanger 100 is disposed downstream of the evaporator 80, with respect to a flow direction of the supply air 212 along the first flow path 154. Similar to the discussion above, suitable ductwork, such as the ductwork 14, extends from the evaporator 80 to the first end portion 156 of the conditioning chamber 122. Accordingly, a flow of conditioned air discharging from the evaporator 80 may enter the conditioning chamber 122 as the supply air 212. Therefore, the first fin array 190 may absorb additional thermal energy from the pre-conditioned supply air 212 before the supply air 212 is discharged from the thermoelectric heat exchanger 100 as the conditioned air 218. In yet further embodiments, an HVAC system, such as the HVAC unit 12, may include a first thermoelectric heat exchanger disposed upstream of the evaporator 80 and a second thermoelectric heat exchanger disposed downstream of the evaporator 80. Accordingly, the thermoelectric heat exchanger 100 may condition a flow of supply air before and after the flow of supply air is directed across the evaporator 80.

Similar to the first flow generating device 210 discussed above, a second flow generating device 220, or a set of second flow generating devices 220, is configured to draw a working fluid 222, such as air from the ambient environment, through a second set of louvers 224 and into the second flow path 162. The second flow generating device 220 and the second set of louvers 224 may be communicatively coupled to the controller 200 and operate similarly to the first flow generating device 210 and the first set of louvers 214 discussed above. The second flow generating device 220 directs the working fluid 222 across the second fin array 194, which, in some embodiments, has a temperature greater than a temperature of the working fluid 222. Similar to the supply air 212 and the first fin array 190 discussed above, a flow direction of the working fluid 222 along the second flow path 162 may be crosswise to an orientation of the second fin array 194, which extends along direction 152. As such, the working fluid 222 flowing across the second fin array 194 may absorb thermal energy therefrom and discharge from the second fin array 194 as a heated fluid 226. The heated fluid 226 is directed along the second flow path 162 and discharged from the working fluid chamber 124 to an ambient environment through the second end portion 166. It should be noted that the second flow generating device 220 may be omitted from the working fluid chamber 124, or temporarily disabled from operation, in certain embodiments of the thermoelectric heat exchanger 100. In such embodiments, the second fin array 194 may transfer energy to the working fluid 222 or absorb thermal energy from the working fluid 222 through convective heat transfer. It should be noted that the divider plate 146 may be constructed of a thermally insulating material, such as foam, plastic, fiberglass, or the like, such that the divider plate 146 may mitigate heat transfer directly between the conditioned air 218 and the heated fluid 226. In other embodiments, a thermally insulating material such as aluminum wrap, cork, rubber, or any other suitable insulating material may be disposed about and/or coupled to the divider plate 146.

Although the supply air 212 and the working fluid 222 are shown as flowing from the upstream end portion 110 to the downstream end portion 112 in the illustrated embodiment of FIG. 6, it should be noted that, in certain embodiments, the first and second flow generating devices 210, 220 may direct the supply air 212 and the working fluid 222, respectively, from the downstream end portion 112 to the upstream end portion 110. In yet further embodiments, a flow direction of the supply air 212 may be opposite of a flow direction of the working fluid 222. For example, the first flow generating device 210 may direct the supply air 212 from the upstream end portion 110 to the downstream end portion 112, while the second flow generating device 220 directs the working fluid 222 from the downstream end portion 112 to the upstream end portion 110.

In some embodiments, the thermoelectric heat exchanger 100 may further include a return duct 230 or a return chamber 230, which is in fluid communication with the conditioning chamber 122 via an aperture 232. The return chamber 230 defines a third flow path 233, or a return air flow path, that is configured to receive return air 234 from the building 10, the ductwork 14, or other structure. In some embodiments, the return air 234 may include a portion of the conditioned air 218 that has circulated from the second end portion 158 of the conditioning chamber 122 through an interior of the building 10. The return chamber 230 may direct the return air 234 through the aperture 232, which is disposed upstream of the first fin array 190. Accordingly, the return air 234 may mix with the supply air 212, such that the supply air 212 and the return air 234 may be conditioned via the first fin array 190. As such, a mixture of the supply air 212 and the return air 234 may discharge from the first fin array 190 as the conditioned air 218. In some embodiments, the return air 234 may be of a lower temperature than the supply air 212 entering the conditioning chamber 122 and thus reduce a temperature of the air supply. Accordingly, recirculating a portion of the return air 234 through the conditioning chamber 122 may enhance an operational efficiency of the thermoelectric heat exchanger 100 because the thermoelectric devices 172 may transfer less thermal energy from the conditioning chamber 122 to the working fluid chamber 124 while still maintaining a desired target temperature of the conditioned air 218.

In some embodiments, the return chamber 230 includes a damper 236 that is configured to modulate an amount of the return air 234 that is recirculated to the conditioning chamber 122. For example, the damper 236 may be disposed above a second aperture 238 that is in fluid communication with the ambient environment. The damper 236 may transition between an open position and a closed position and, accordingly, increase or decrease, respectively, an amount of the return air 234 flowing toward the conditioning chamber 122. For example, while the damper 236 is in an open position, substantially all of the return air 234 may be directed toward the conditioning chamber 122. Conversely, the damper 236 may enable substantially all of the return air 234 to discharge through the second aperture 238 as exhaust air 240 while the damper 236 is in the closed position. It should be noted that, in certain embodiments, the damper 236 and the second aperture 238 may be disposed upstream of the return chamber 230, such as in separate ductwork preceding the return chamber 230. In such embodiments, substantially all return air 234 flowing into the return chamber 230 is directed into the conditioning chamber 122 via the aperture 232.

In some embodiments, an amount of the return air 234 recirculating to the conditioning chamber 122 is based on feedback received from one or more sensors 242 disposed within the housing 108 of the thermoelectric heat exchanger 100, the conditioning chamber 122, the working fluid chamber 124, the return chamber 230, the ductwork 14, the building 10, or any other suitable portion of the HVAC system. For example, the one or more sensors 242 may include, but are not limited to, temperature sensors, humidity sensors, carbon dioxide sensors, flow rate sensors, or any other suitable sensors configured to measure certain operational parameters of the thermoelectric heat exchanger 100 and/or the HVAC system. Each of the one or more sensors 242 may be communicatively coupled to the controller 200. As described in greater detail herein, the controller 200 may instruct the damper 236 to reduce an amount of the return air 234 recirculating into the conditioning chamber 122 when a predetermined operational parameter measured by one of the one or more sensors 242 deviates from a target value by a threshold amount.

As a non-limiting example, the one or more sensors 242 may include a carbon dioxide sensor 244 that is disposed within the return chamber 230. The carbon dioxide sensor 244 may measure a carbon dioxide concentration in the return air 234 entering the return chamber 230. The controller 200 may compare the measured carbon dioxide concentration to a predetermined target value that may be stored in the memory device 204 of the controller 200. If the measured carbon dioxide concentration is below the predetermined target value by a threshold amount, the controller 200 may instruct the damper 236 to move toward an open position, such that an amount of the return air 234 recirculating into the conditioning chamber 122 is increased. Conversely, if the measured carbon dioxide concentration of the return air 234 is above the predetermined target value by a threshold amount, the controller 200 may instruct the damper 236 to move toward the closed position, and thus, decreases an amount of the return air 234 entering the conditioning chamber 122 through the aperture 232. Accordingly, the controller 200 may maintain a carbon dioxide concentration of the air within the building 10 at or below a value that is substantially similar to the predetermined target value of the carbon dioxide concentration. The controller 200 may similarly adjust an amount of the return air 234 recirculating to the conditioning chamber 122 based on feedback acquired from other sensors of the one or more sensors 242.

Similar to the discussion above, the controller 200 may instruct the thermoelectric devices 172 to adjust a temperature of the conditioned air 218 discharged from the conditioning chamber 122 in response to feedback acquired by the one or more sensors 242. For example, the one or more sensors 242 may include temperatures sensors 250 that are disposed within the conditioning chamber 122, the working fluid chamber 124, the building 10, the return chamber 230, or any other suitable portion of the HVAC system. For example, the temperature sensors 250 may be configured to measure a temperature of individual zones of the building 10. The controller 200 receives feedback indicative of an air temperature acquired by each of the temperature sensors 250 and compares the feedback to a predetermined target value. If the feedback deviates from respective target values by a threshold amount, the controller 200 may adjust certain operational parameters of the thermoelectric heat exchanger 100.

For example, if the controller 200 determines that feedback indicative of a measured temperature of the conditioned air 218 exceeds a predetermined target temperature by a threshold amount, the controller 200 may, for example, increase a magnitude of the electric current supplied to the thermoelectric devices 172. Accordingly, a rate of heat transfer between the first and second heat exchange surfaces 184, 186 is increased. As such, in some embodiments, a temperature of the first heat exchange surface 184 and the first fin array 190 decreases while a temperature of the second heat exchange surface 186 and the second fin array 194 increases. Accordingly, a temperature differential between the first fin array 190 and the supply air 212 is increased, such that a rate of heat transfer between the first fin array 190 and the supply air 212 is increased. Similarly, a temperature differential between the second fin array 194 and the working fluid 222 is also increased, such that a rate of heat transfer between the second fin array 194 and the working fluid 222 is enhanced. As such, the controller 200 may decrease a temperature of the conditioned air 218 flowing across the first fin array 190.

Additionally or otherwise, the controller 200 may increase an operational speed of the first flow generating device 210 and/or the second flow generating device 200 in response to determining that a temperature of the conditioned air 218 exceeds a predetermined target temperature by a threshold amount. Accordingly, a flow rate of air along the first flow path 154 and the second flow path 162 may be increased, which, in certain embodiments, may further increase a rate of heat transfer from the first fin array 190 to the second fin array 194, and thus, decrease a temperature of the conditioned air 218. As such, the controller 200 may regulate operation of the thermoelectric heat exchanger 100 to maintain a temperature of the conditioned air 218 at or near a predetermined target temperature.

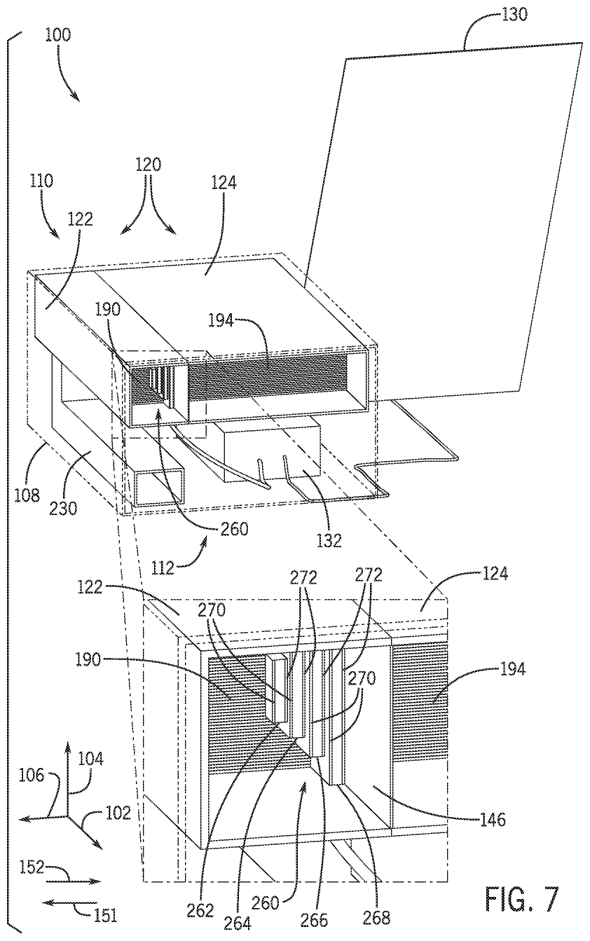

FIG. 7 is a perspective view of the downstream end portion 112 of the thermoelectric heat exchanger 100. As noted above, the thermoelectric devices 172 may be disposed in a pyramidal arrangement, referred to herein as a cascaded arrangement 260, within the conditioning chamber 122, which may enhance an operational efficiency of the thermoelectric heat exchanger 100. For example, in some embodiments, the cascaded arrangement 260 may include a first thermoelectric device 262, a second thermoelectric device 264, a third thermoelectric device 266, and a fourth thermoelectric device 268, which are stacked against one another, arranged along the lateral axis 106. Each of the first, second, third, and fourth thermoelectric devices 262, 264, 266, 268 includes a pair of respective heat exchange surfaces, referred to herein as a cold side 270, or a first side, and a hot side 272, or a second side. A size or a cross-sectional area of the respective heat exchange surfaces of the first, second, third, and fourth thermoelectric devices 262, 264, 266, 268 may increase from the first thermoelectric device 262 to the fourth thermoelectric device 268 along the lateral direction 151. This configuration may enable the hot side 272 of the first thermoelectric device 262 to couple to a portion of the cold side 270 of the second thermoelectric device 264, the hot side 272 of the second thermoelectric device 264 to couple a portion of the cold side 270 of the third thermoelectric device 266, and so on.

The cascaded arrangement 260 may extend across at least a portion of the first flow path 154 of the conditioning chamber 122. For example, in some embodiments, the hot side 272 of the fourth thermoelectric device 268 may be disposed within the gap 170 and coupled to the divider plate 146, such that a remaining portion of the cascaded arrangement 260 extends in the direction 152 into the first flow path 154 of the conditioning chamber 122. The first fin array 190 may conform to a cross-sectional shape of the cascaded arrangement 260, such that an exposed portion of the cold side 270 of each of the first, second, third, and fourth thermoelectric devices 262, 264, 266, 268 is coupled to the first fin array 190. In some embodiments, the cascaded arrangement 260 may enable a temperature differential between the cold side 270 of the first thermoelectric device 262 and the hot side 272 of the fourth thermoelectric device 268 to be 100 degrees Celsius or more. Accordingly, the cascaded arrangement 260 may facilitate further decreasing a temperature of the first fin array 190, and thus, increase a temperature differential between the supply air 212 and the first fin array 190. This increase in temperature differential may enhance a rate of heat transfer between the supply air 212 and the first fin array 190.

The cascaded arrangement 260 may also increase a temperature differential between the second fin array 194 coupled to the hot side 272 of the fourth thermoelectric device 268 and the working fluid 222. Similar to the first fin array 190 and the supply air 212 discussed above, increasing a temperature differential between the second fin array 194 and the working fluid 222 may also enhance a rate of heat transfer therebetween. Further, in some embodiments, the increased temperature of the second fin array 194 may enable a temperature of the working fluid 222 to be relatively warm, while still enabling the working fluid 222 to absorb thermal energy from the second fin array 194. It should be noted that the cascaded arrangement 260 may include additional or fewer staggered thermoelectric devices than those discussed in the exemplary embodiment above. For example, the cascaded arrangement 260 may include 2, 3, 4, 5, 6, or more than six thermoelectric devices that are coupled to one another in a staggered arrangement.

Returning now to FIG. 5, as noted above, the thermoelectric heat exchanger 100 may include solar array 130 that includes one or more solar panels 278, which are electrically coupled to the control unit 132 and/or the controller 200 of the thermoelectric heat exchanger 100. The solar array 130 generates electrical energy while solar radiation is incident on a surface 280 of the solar array 130. The control unit 132 may store the generated electrical energy in a battery module 282, such as a lithium ion battery or a lithium polymer battery, which is disposed within the control unit 132. In some embodiments, the battery module 282 may be used to power the thermoelectric devices 172 disposed within the thermoelectric heat exchanger 100. The battery module 282 may be sized to enable the thermoelectric devices 172 to operate for a predetermined time period using stored electrical energy supplied from the battery module 282, even while the solar array 130 generates negligible, or no electrical energy. For example, the battery module 282 may be configured to power the thermoelectric devices 172 for 1, 2, 3, 4, 5, 6, 12, 24, or more than 24 hours without receiving electrical energy from the solar array 130.

In certain embodiments, the battery module 282 may further supply electrical energy to the one or more sensors 242, the first flow generating device 210, the second flow generating device 220, or any other suitable component of the thermoelectric heat exchanger 100. Accordingly, the thermoelectric heat exchanger 100 may operate as a stand-alone unit that is not reliant upon electrical energy from an external power source, such as a stationary or utility power grid. However, in other embodiments, certain components of the heat exchanger 100 may be electrically coupled to an external power source and configured to receive electrical energy therefrom.

In some embodiments, the battery module 282 may also couple to the external power source, such that the external power source may be used to charge the battery module 282 if the solar array 130 is unable to generate a sufficient amount of electrical energy to maintain a battery level of the battery module 282 above a threshold value. For example, if an amount of solar radiation incident upon the solar array 130 during certain operational time periods of the thermoelectric heat exchanger 100 is insufficient to enable the solar array 130 to maintain the battery level of the battery module 282 above the threshold value, the controller 200 may direct a flow of electrical energy from the external power source to the battery module 282 to charge the battery module 282. Accordingly, electrical energy from the external power source may be used in addition to the electrical energy generated by the solar array 130 the charge the battery module 282.

Technical effects of present embodiments include improved operational efficiency and reliability of HVAC systems. For example, the thermoelectric heat exchanger 100 may be used to pre-condition a flow of air flowing across heat exchangers of a vapor compression system. By pre-conditioning the flow of air, the thermoelectric heat exchanger 100 may reduce an amount of thermal energy exchanged between the heat exchangers via a refrigerant during operation of the vapor compression system, which may reduce a power consumption of the HVAC system. In some cases, the HVAC system may use the thermoelectric heat exchanger 100 in lieu of a vapor compression system to condition a flow of air. Accordingly, the thermoelectric heat exchanger 100 may reduce a quantity of valves, pipes, and/or additional heat exchangers within the HVAC system that may incur wear, clogs, or leaks over time. In addition, the thermoelectric heat exchanger 100 may be powered via electrical energy that is generated by a solar array electrically coupled to the thermoelectric heat exchanger 100. As such, the thermoelectric heat exchanger 100 may draw a reduced, or substantially negligible amount of power from a stationary power grid, which may further enhance an operational efficiency of the HVAC system.

As discussed above, the aforementioned embodiments of the thermoelectric heat exchanger 100 may be used on the HVAC unit 12, the residential heating and cooling system 50, or with any other suitable HVAC system. However it should be noted that the specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A heating, ventilation, and/or air conditioning (HVAC) system, comprising:
a heat exchanger configured to thermally regulate a supply air flow, wherein the heat exchanger comprises:
a thermoelectric device;
a first plurality of fins coupled to the thermoelectric device, wherein the first plurality of fins extend into a supply air flow path of the supply air flow to transfer thermal energy between the thermoelectric device and the supply air flow; and
a second plurality of fins coupled to the thermoelectric device, wherein the second plurality of fins convectively transfer thermal energy between the thermoelectric device and a working fluid exterior the supply air flow path.

2. The HVAC system of claim 1, wherein the thermoelectric device comprises a first heat exchange surface coupled to the first plurality of fins, and a second heat exchange surface coupled to the second plurality of fins.

3. The HVAC system of claim 1, wherein the thermoelectric device is configured to transfer thermal energy absorbed from the supply air flow in the supply air flow path to the working fluid exterior the supply air flow path via the second plurality of fins.

4. The HVAC system of claim 1, wherein the thermoelectric device is configured to transfer thermal energy absorbed from the working fluid exterior the supply air flow path to the supply air flow in the supply air flow path via the first plurality of fins.

5. The HVAC system of claim 4, wherein the second plurality of fins extends into a working fluid flow path configured to receive a flow of the working fluid, wherein the working fluid flow path directs the flow of the working fluid across the second plurality of fins.

6. The HVAC system of claim 1, wherein the thermoelectric device extends into the supply air flow path.

7. The HVAC system of claim 1, comprising a flow generating device disposed within the supply air flow path, wherein the flow generating device is configured to force the supply air flow across the first plurality of fins.

8. The HVAC system of claim 1, further comprising:
a sensor in fluid communication with the supply air flow path; and
a controller electrically coupled to the sensor and the thermoelectric device, wherein the controller is configured to adjust an electric current supplied to the thermoelectric device in response to feedback acquired by the sensor.

9. The HVAC system of claim 8, further comprising:
a battery module electrically coupled to the thermoelectric device and configured to supply the electric current thereto; and
a solar panel electrically coupled to the battery module, wherein the solar panel is configured to supply an additional electric current to the battery module.

10. The HVAC system of claim 1, comprising an evaporator in fluid communication with the heat exchanger, wherein the evaporator is disposed downstream of the first plurality of fins relative to a direction of the supply air flow along the supply air flow path, and wherein the evaporator is configured to receive the supply air flow and absorb thermal energy from the supply air flow.

11. The HVAC system of claim 1, comprising an evaporator in fluid communication with the heat exchanger, wherein the evaporator is disposed upstream of the first plurality of fins relative to a direction of the supply air flow along the supply air flow path, and wherein the evaporator is configured to receive the supply air flow and absorb thermal energy from the supply air flow.

12. The HVAC system of claim 1, wherein the heat exchanger comprises an enclosure having the thermoelectric device, the supply air flow path, and a working fluid flow path through which the working fluid flows.

13. A heating, ventilation, and/or air conditioning (HVAC) system, comprising:
a heat exchanger configured to thermally regulate a supply fluid, wherein the heat exchanger comprises:
a first chamber that defines a first flow path for the supply fluid;
a second chamber that defines a second flow path for a working fluid; and
a thermoelectric device disposed between the first chamber and the second chamber, wherein the thermoelectric device comprises a first heat exchange surface and a second heat exchange surface, wherein a first plurality of fins is coupled to the first heat exchange surface and extends into the first flow path and a second plurality of fins is coupled to the second heat exchange surface and extends into the second flow path, and wherein the thermoelectric device is configured to transfer thermal energy between the supply fluid and the working fluid.

14. The HVAC system of claim 13, comprising a first flow generating device disposed within the first chamber and configured to force the supply fluid through the first chamber and a second flow generating device disposed within the second chamber and configured to force the working fluid through the second chamber.

15. The HVAC system of claim 13, further comprising a third chamber fluidly coupled to the first chamber via an aperture, wherein the third chamber defines a third flow path for a return fluid.

16. The HVAC system of claim 15, wherein the aperture is disposed upstream of the first plurality of fins relative to a flow direction of the supply fluid.

17. The HVAC system of claim 13, comprising a divider panel disposed between the first chamber and the second chamber, and wherein the divider panel comprises a thermally insulating material.

18. The HVAC system of claim 13, further comprising:
a plurality of sensors disposed within the first flow path, the second flow path, or both; and
a controller communicatively coupled to the plurality of sensors, wherein the controller is configured to control the thermoelectric device to adjust a rate of heat transfer between the supply fluid and the working fluid based on feedback from a sensor of the plurality of sensors.

19. The HVAC system of claim 18, wherein the plurality of sensors comprises a temperature sensor, a humidity sensor, a carbon dioxide sensor, a flow rate sensor, or any combination thereof.

20. The HVAC system of claim 18, wherein the controller is communicatively coupled to at least one flow generating device within the first chamber, the second chamber, or both, and the controller is configured to modulate an operational speed of the at least one flow generating device based on the feedback from the sensor.
